(19) United States
(12) Patent Application Publication
(10) Pub. No.: US 2019/0375581 A1
(43) Pub. Date: Dec. 12, 2019

(54) SYSTEM AND METHOD FOR CREATING CONSUMABLE JUICE PRODUCTS

(71) Applicant: Helen Vo, Huntington Beach, CA (US)

(72) Inventor: Helen Vo, Huntington Beach, CA (US)

(21) Appl. No.: 16/005,218

(22) Filed: Jun. 11, 2018

(51) Int. Cl. B65D 85/804; B65D 51/24; A23L 2/02; A23L 2/42; A23L 3/37

(52) U.S. Cl. CPC B65D 85/804; B65D 51/245; A23V 2002/00; A23L 2/42; A23L 3/37; A23L 2/02

(57) ABSTRACT

A system for creating a customizable juice beverage is provided. The system includes a plurality of individual juice pods, each having a consumable juice substance stored therein and configured to be combined with additional consumable juice substances to create the customizable juice beverage. Each juice pod can include a container having a cavity for holding the consumable juice substance and a top for enclosing the consumable juice substance in the cavity. Each juice pod can include a color-coded label identifying a characteristic of the consumable juice substance in the juice pod. Each consumable juice substance can be processed from a juicing product that can include a vegetable, a fruit, a nutritional supplement, or other consumable product. The individual juice pods can each contain a consumable juice substance derived from a different juicing product to enable the creation of a customizable juice beverage based on the preferences of a user.

### CROSS-REFERENCE TO RELATED APPLICATIONS

None.

### FIELD OF THE INVENTION

The present invention is directed generally to systems and methods for creating consumable juice products and in particular, individual juice pods for creating customized consumable juice beverages.

### BACKGROUND OF THE INVENTION

Consumers often have a desire to create and consume juice-based beverages for the several nutritional and health benefits provided by juicing substances such as fruits, vegetables and other products. However, the process for creating a liquid juice product from one or more fruits, vegetables and other products can be intensive, costly and time consuming. For example, in order to create different types of juicing beverages, consumers are currently required to purchase and store a large amount and variety of juicing products, such as fruits and vegetables, which require a significant amount of storage space and have a relatively short shelf life, resulting in significant amounts of waste. Further, consumers are required to juice each of the products, which require juicing machines, significant preparation and significant cleaning.

Currently available solutions and products are available for providing premade juicing beverages. However, such products do not enable consumers to create customized juice beverages based on the users preferences and needs and often are provided in large containers and quantities that restrict consumer's ability to create customized juicing beverages and do not maintain freshness of the juicing contents.

Accordingly, a need exists for systems and methods that can enable a user to create a customized juice beverage that is convenient, easy to use and that can maintain the freshness of the juicing products used to create the customized juice beverage.

### SUMMARY OF THE INVENTION

The present invention is directed to systems and methods for creating individual juice pods for use in a customizable juice beverage and systems and products for creating customizable juice beverages from individual juice pods. According to one embodiment of the present invention, a system for providing a customizable juice-based beverage comprises a plurality of individual juice pods. Each individual juice pod can include an enclosed cavity and a consumable juice substance provided in the cavity. In accordance with one embodiment of the invention, the system and the individual juice pods comprising the system can enable a user to create a customized juice beverage having a variety of juicing products without having to store a variety of juicing products or individually prepare and juice separate juicing products.

According to one embodiment of the invention, the consumable juice substance stored in each individual juice pod can be created or derived from a juicing product. The juicing product can comprise fruits, vegetables, grains, seeds, nuts, legumes, diary products, milk products, vitamins, minerals, nutritional supplements, probiotics, extracts, teas, leaves, herbs, spices and other consumable products. The consumable juice substance can be in the form of a liquid, solid, powder, jelly or other solid or liquid state. Each individual juice pod included in the system can contain a consumable juice substance from a different juicing product in order to enable a user to select one or more individual juice pods based on the user's preferences to combine together to create a customizable juice beverage. According to one embodiment of the invention, the system can allow a user to choose the specific ingredients to include in the customizable juice beverage based on the user's desired nutrients, flavors and juice products by selecting the individual juice pods containing consumable juice substances matching the user's preferences.

The present invention is further directed to a customizable juice product for creating a customized juice beverage. The customizable juice product can include a plurality of individual juice pods, each comprising a container having a cavity defined therein, a top or lid enclosing the cavity, and a consumable juice substance provided in the cavity, where the consumable juice substance is prepared from a juicing product having one or more nutritional or flavor characteristics. The plurality of individual juice pods can comprise a first individual juice pod having a first consumable juice substance prepared from a first juicing product and a second individual juice substance prepared from a second juicing product, where the first juicing product is different from the second juicing product.

The present invention is further directed to a method for creating a customizable juice product having a plurality of individual juice pods. The method can comprise the steps of: providing a first juicing product; processing the first juicing product into a first consumable juice substance; providing a first individual juice pod having a cavity; placing the first consumable juice substance in the cavity of the first individual juice pod; sealing the first individual juice pod to enclose the first consumable juice substance in the cavity; placing a label on the first individual juice pod, wherein the label identifies at least one characteristic of the first consumable juice substance; providing a second juicing product, the second juicing product being different from the first juicing product; processing the first juicing product into a second consumable juice substance; providing a second individual juice pod having a cavity; placing the second consumable juice substance in the cavity of the second individual juice pod; sealing the second individual juice pod to enclose the second consumable juice substance in the cavity; and placing a label on the second individual juice pod, wherein the label identifies at least one characteristic of the second consumable juice substance.

According to one embodiment of the invention, each individual juice pod can include a color-coded label provided on the exterior of the juice pod that identifies a characteristic associated with the consumable juice substance contained within the juice pod to enable the user to easily select a combination of individual juice pods used in the creation of the customizable juice beverage.

The prevent invention can provide several benefits and advantages as compared to traditional juice products, including, but not limited to: allowing users to easily create customized juices based on diet, nutrition, flavor and user preferences, without the hassle of preparing juicing ingredients; allowing a user to know the exact amount of each juicing ingredient in a juice (many pre-made juices list ingredients but do not identify the amounts of each ingredient); allowing a user to add more variety into their juices, including ingredients that are not locally available; allowing a user to include specific juicing ingredients for their nutritional or other benefits (such as prickly pear cactus for cholesterol, bitter melon for diabetes, carrots for vision, etc.); and allowing a user to control the amount of specific ingredients included in their juice (e.g., a user can control the amount of sugar included in their juice as many pre-made juices contain significant amounts of sugar).

Other aspects and advantages of the present invention will be apparent from the following detailed description of the preferred embodiments of the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic perspective view of a system for creating a customizable juice beverage in accordance with one embodiment of the present invention;

FIG. 2A is a schematic perspective view of a juice pod used in creating a customizable juice beverage in accordance with one embodiment of the present invention;

FIG. 2B is a top plan view of the juice pod of FIG. 2A;

FIG. 2C is a sectional view of the juice pod of FIG. 2A, illustrating an interior of the juice pod;

FIG. 2D is a schematic perspective view of the juice pod of FIG. 2A illustrating the juice pod after being opened in accordance with one embodiment of the present invention;

FIG. 3A is a schematic perspective view of a juice pod used in creating a customizable juice beverage in accordance with another embodiment of the present invention;

FIG. 3B is a top plan view of the juice pod of FIG. 3A;

FIG. 4A is a schematic perspective view of a juice pod used in creating a customizable juice beverage in accordance with another embodiment of the present invention;

FIG. 4B is a top plan view of the juice pod of FIG. 4A;

FIG. 5 is a schematic perspective view of a system and product for creating a customizable juice beverage in accordance with one embodiment of the present invention;

FIG. 6 is a schematic flow chart of a method for creating one or more juice pods for use in creating a customizable juice beverage in accordance with one embodiment of the present invention;

FIG. 7 is a schematic flow chart of a method for creating one or more juice pods for use in creating a customizable juice beverage in accordance with another embodiment of the present invention; and

FIG. 8 is a schematic flow chart of a method for creating one or more juice pods for use in creating a customizable juice beverage in accordance with another embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention relates to systems and methods for creating individual juice pods containing different varieties of consumable juice substances. The present invention further relates to systems, products and methods for creating and providing customizable juice beverages that can be created from one or more individual juice pods. As described in greater detail herein, the present invention can enable the creation of a customizable juice beverage by providing one or more juice pods, each having a consumable juice substance contained therein that can be derived from a juicing product or other nutritional or consumable product. The individual juice pods allow for the convenient creation of a customized juice beverage having any desired combination of consumable juice products, nutrients and flavors. In order to create a customized juice beverage as described in connection with the systems, products and methods of the present invention, one or more individual juice pods can be opened and combined together based on a desired set of nutritional, flavor or other preferences. While the various techniques described herein refer to the use of consumable “juice” substances (e.g., fruit- and vegetable-based juice products) for purposes of clarity, simplicity and convenience, it is recognized and anticipated that any number of different types of consumable substances, including non-traditional juice-type substances may also be utilized in connection with the present invention, including, but not limited to, nutritional and flavor supplements, probiotics, teas, dairy products, yogurt, nuts, seeds, grains, legumes, beans, extracts and any other type of consumable substances.

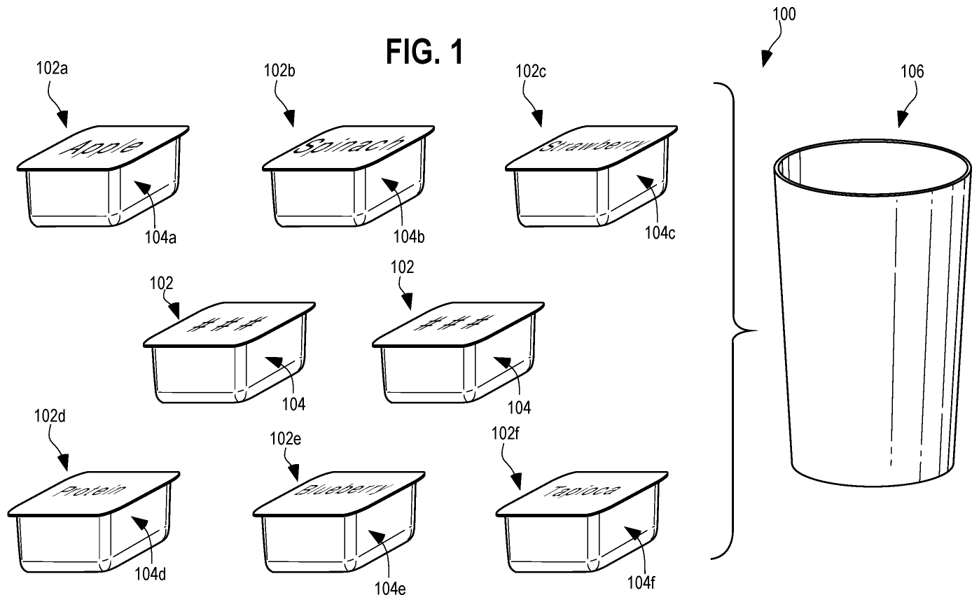

Referring to FIG. 1, a system or product 100 for providing a customizable juice-based beverage is shown schematically according to one embodiment of the present invention. As shown, system or product 100 can comprise a plurality of individual juice packets or pods 102. Each juice pod 102 can contain a quantity of a specific type of a consumable juice substance 104 that is created from a specific fruit, vegetable, nutritional supplement, flavor supplement or other consumable substance, or any combination thereof, as described in greater detail below. As shown in FIG. 1, the juice pods 102 (and system 100) can be used to create a customizable juice-based beverage 106 by combining the consumable juice substance 104 of one or more juice pods 102 in a container or vessel based on the preferences and desired juice profile of a user. As described in greater detail below, each juice pod 102 can contain a different consumable juice substance 104 processed and/or derived from a juicing product (e.g., a fruit or vegetable) or other consumable substance, enabling the user to select one or more juice pods 102 based on the nutritional, flavor or other characteristics of the consumable juice substances 104 contained therein to create the customizable juice-based beverage.

As shown by example in FIG. 1, each juice pod 102 of system 100 can include a consumable juice substance 104 processed from a different juicing product or other type of consumable product to enable the user to create a customized combination of one or more fruits, vegetables, nutrients, flavors and other consumable products into a single juice-based beverage. As illustrated in FIG. 1, according to one embodiment, system 100 can include a juice pod 102a containing an apple-based consumable juice substance 104a, a juice pod 102b containing a spinach-based consumable juice substance 104b, a juice pod 102c containing a strawberry-based consumable juice substance 104c, a juice pod 102d containing a protein supplement-based consumable juice substance 104d, a juice pod 102e containing a blueberry-based consumable juice substance 104e, and a juice pod 102f containing a tapioca-based consumable juice substance 104f. System 100 can include any number juice pods 102 containing different or additional types of consumable substances 104 and the foregoing identified types of consumable substances 104 are provided for exemplary purposes only. For example, additional or alternative consumable substances 104 can include, but are not limited to: oranges, lemons, pomegranate, pineapples, mangos, raspberries, carrots, kale, celery, broccoli, and all other types of fruits and vegetables; Lactobacillus, Bifidobacterium, Saccharomyces, boulardii and other probiotics; yeast; fermented fruits and vegetables; kombucha; kvass; chia seeds; various types of seeds, nuts, oats, grains, leaves, flowers, plants, roots, beans, and legumes; honeys; various types of teas; aloe vera; caffeine; proteins and protein supplements; alcohols; various types of vitamins and minerals; milk products; milk, yogurt, Greek yogurt and other milk and dairy products; tapioca, boba and other cassava root-based products; soy, edamame, and other soy-based products; wheat bran and other brans; teff, bulgur and other cereal products; various types of vinegars; ginger; coffee; sterols and stanols; chlorella, Spirulina, alga and seaweeds; mushrooms; various types of spices and herbs; kefir; bone broths; cocoa; turmeric; and jellies.

As represented schematically in FIG. 1, in order to create a customizable juice beverage 106, one or more juice pods 102 can be opened and the contents (i.e., the consumable juice substance 104 contained therein) of each selected juice pod 102 can be placed into suitable container or vessel and mixed together to create the customizable juice beverage 106 with a juice profile desired by the user. As described in greater detail below, depending on the particular embodiment of a consumable juice substance 104 for a juice pod 102, the consumable juice substance 104 can be in the form of a liquid, frozen solid, powder, jelly, or solid. In addition, the consumable juice substances 104 of the selected juice pods 102 can be mixed with water, liquid juice or other consumable liquid to create the customizable juice beverage 106. Users can also decide to select only a single juice pod 102 and directly consume the consumable substance 104 contained therein.

The system 100 can allow a user to choose the specific ingredient(s) to include in customizable juice beverage 106 based on the user's desired nutrients, flavors and juice products. By way of example only, the user can select to combine juice pod 102b containing a spinach-based consumable substance 104b, juice pod 102c containing a strawberry-based consumable substance 104c and juice pod 102f containing a tapioca-based consumable substance 104f to create a spinach-strawberry-tapioca juice beverage 106. Alternatively, the user can select to combine juice pods 102a, 102c, 102d and 102e to create a customizable juice beverage 106 containing apple, strawberry, and blueberry juices along with a protein supplement. Any desired type of combination can be selected by the user to create a customizable juice beverage 106, including selecting two or more of the same type of juice pod 102 containing the same type of consumable juice substance 104. For example, if a user wants to add more fiber to their diet (such as based on a recommendation for a doctor or nutritionist), then the user could create customized juice beverage 106 by selecting one or more juice pods 102 containing a consumable juice substance 104 having high fiber characteristics (such as a raspberry-based or chia seed-based consumable substance 104) and adding the substances 104 from juice pods 102 to a container having a juice or water or other juice pod 102 contents. System 100 further enables users to create a customizable juice beverage 106 having any desired combination of fruits, vegetables, supplements and other consumable products without having to store the physical consumable products (e.g., fruits and vegetables) or conduct the juicing of the products. Accordingly, system 100 provides a convenient means for creating a customized juice beverage 106 from a variety of juicing substances based a set of user preferences.

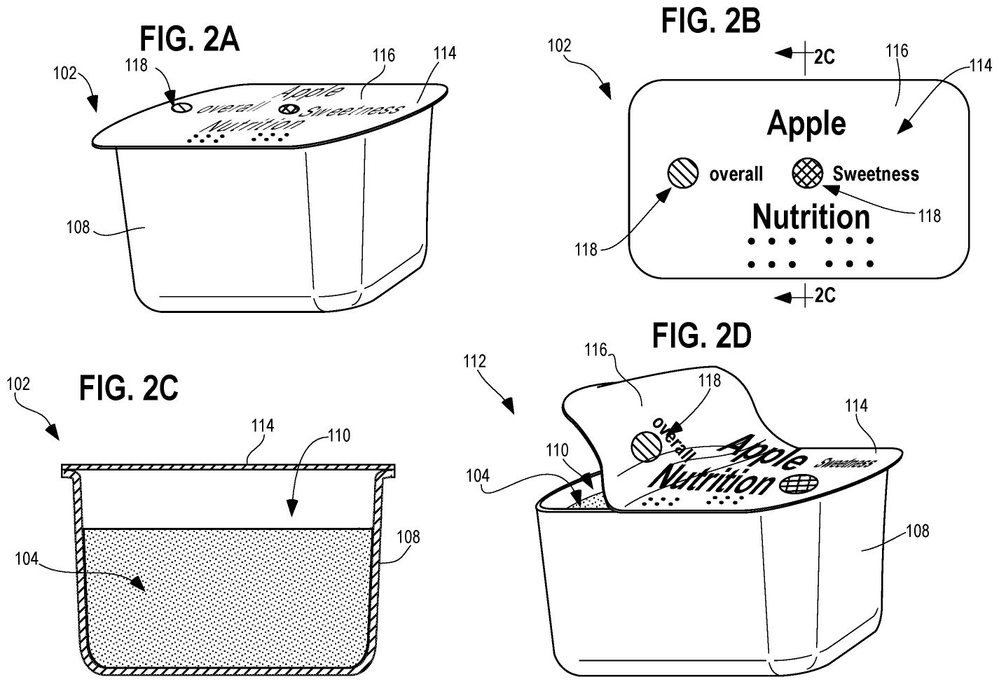

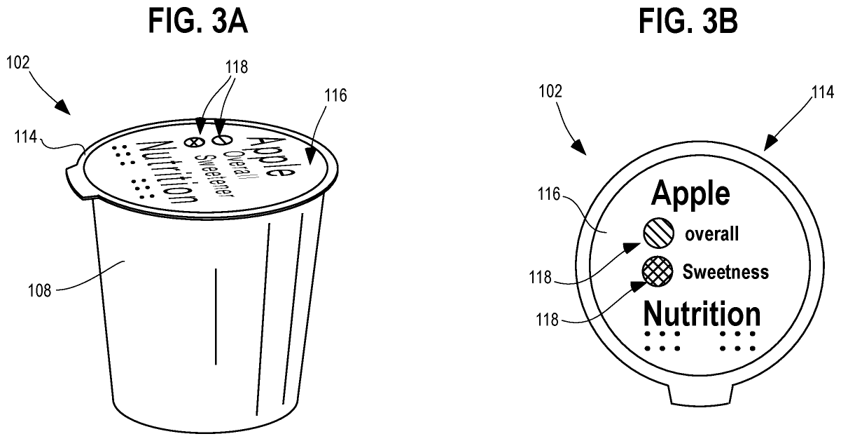

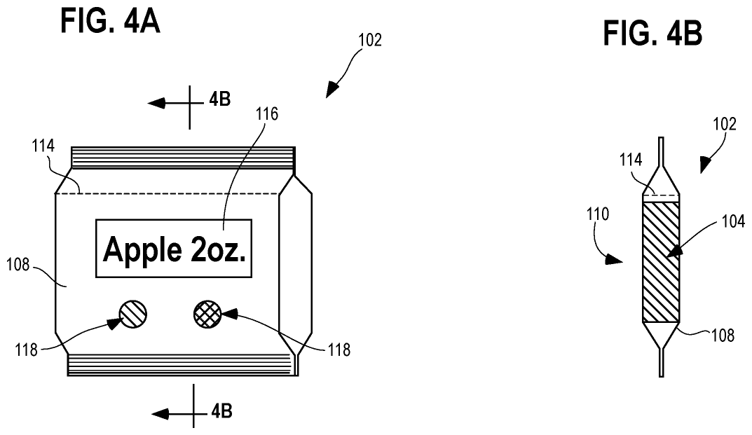

Turning to FIGS. 2A-2D, the shape and configuration of the juice pods 102 according to one embodiment will be described in greater detail. Each juice pod 102 can comprise a container 108 produced from a plastic material, coated paperboard material, or other suitable material, including biodegradable and/or recyclable materials. Container 108 can be configured as a rigid, semi-rigid or deformable structure depending on the material used to create container 108 and the desired shape and configuration of container 108 and juice pod 102. Container 108 can further have any desired shape or structure depending on the particular embodiment of the present invention. As shown in FIGS. 2A-2D, according to one embodiment, container 108 (and juice pod 102 overall) can have a generally rectangular or box shape. As shown in FIGS. 3A-3B, according to another embodiment, container 108 (and juice pod 102 overall) can have a generally circular or cylindrical shape. As shown in FIGS. 4A-4B, according to yet another embodiment, container 108 can have a generally flattened sheet-like shape. Any number of different shapes, structures and configurations of juice pod 102 and container 108 are also considered within the scope of the present invention.

As shown in FIGS. 2A-2D, container 108 can define a cavity 110 for holding a specific volume of consumable juice substance 104. As shown, cavity 110 can generally correspond to the shape and structure of container 108 and can define the shape of the volume of the consumable juice substance 104 contained in juice pod 102. According to one embodiment, container 108 can be configured to hold approximately two ounces (2 oz.) of consumable juice substance 104; however, in other embodiments, container 108 (and juice pods 102) can be configured to house greater or lesser volumes or weights of consumable juice substance 104. In addition, each individual juice pod 102 comprising system 100 can be configured to hold a volume or weight of consumable juice substance 104 specific to the particular type of consumable juice substance 104. According to one embodiment, each individual juice pod 102 can be configured to hold a volume or weight of consumable juice substance 104 representing a single serving of the juicing product (or other consumable product) from which the consumable juice substance is created. For example, two cups of spinach can be processed into approximately two ounces for a spinach-based consumable juice substance 104, whereas a single serving of a calcium nutritional supplement may require only one ounce of consumable juice substance 104.

As further shown in FIGS. 2A-2D, container 108 can have an opening 112 defined at the top of the juice pod 102 that can be enclosed by a removable lid or top 114. Lid 114 can be removably secured around opening 112 of container 108 using any suitable method in order to enclose the consumable juice substance 104 contained within cavity 110 of the juice pod 102. As further shown in FIG. 2D, lid 114 can be configured for removal from container 108 in order to provide access to cavity 110 through opening 112 so that a user can remove the consumable juice substance 104 from the opened juice pod 102.

FIGS. 3A and 3B illustrate an alternative configuration of juice pod 102 wherein container 108 is configured with a circular or cylindrical shape as opposed to the rectangular or box shape of container 108 as shown in the embodiment of FIGS. 2A-2D.

FIGS. 4A and 4B illustrate an alternative configuration of juice pod 102 wherein container 108 is in the form of a packet and lid 114 can be configured as a tear strip, perforation, seam or other suitable opening means 114 in order to enable a user to easily open container 108 and access cavity 110 and the consumable juice substance 104 contained therein. In addition, as best shown in FIG. 4B, the shape of juice pod 102 and container 108 according to this embodiment can shape the volume of the consumable juice substance 104 contained therein in a thin sheet with a narrow width or thickness. This configuration can facilitate faster melting of the consumable juice substance 104 once removed from juice pod 102 when consumable juice substance 104 is in the form of a frozen substance. This configuration can further allow several consumable juice substances 104 to be combined in a frozen state and quickly mixed together for consuming by a user. It is also recognized that juice pods 102 can define and shape the consumable juice substances 104 in any suitable shape and configuration apart from the embodiments in FIGS. 2-4 depending on the desired use and application of the present invention.

As shown schematically in FIGS. 2-4, each juice pod 102 can include a label 116 that can placed on lid 114 (see FIGS. 2A-2B and 3A-3B) of juice pod 102 and/or container 108 (see FIGS. 4A-4B) of pod 102. Label 116 and can be used to provide identifying information for the type of consumable juice substance 104 contained within the juice pod 102 and/or additional attributes or characteristics associated with the particular consumable juice substance 104, such as but not limited to substance type, nutritional information, quantity and serving size. For example, as shown in FIG. 2B, label 116 provides the type of consumable juice substance 104 (“Apple” as indicated in FIG. 2B) and certain nutritional attributes of the consumable juice substance 104 (as schematically shown in FIG. 2B). As shown in FIG. 4A, label 116 can include the size of the consumable juice substance 104 (“2 oz.” as indicated in FIG. 4A) in juice pod 102, which can identify the volume, weight, serving size or other type of measurement.

As best shown in FIGS. 2B, 3B and 4A, according to one embodiment, each juice pod 102 can include a color-coded label 118 that can indicate a characteristic or trait associated with the specific type of consumable juice substance 104 contained within the juice pod 102. As shown in FIG. 2B, a juice pod 102 can include multiple color-coded labels 118 depending on the particular nutritional and health benefits and/or effects of the product contained within the consumable juice substance 104 of juice pod 102. In addition, in certain embodiments, container 108 and/or lid 114 can have a specific color in order to identify and/or associate the consumable juice substance 104 contained therein with a type of juice product or an attribute of a juice product.

Each color-coded label 118 can enable a user to select juice pods 102 for use in the customizable juice beverage 106 based on desired characteristics of the consumable substances 104 contained within the selected juice pods 102. Because users of system 100 may not always be familiar with the taste, flavor and/or nutritional characteristics of a particular consumable juice substance 104, the color-coded labels 118 can assist users in identifying and selecting the particular juice pods 102 for use in a customizable juice beverage 106 in order to create the customizable juice beverage in accordance with the user's preferences. According to one embodiment, the color-coded label 118 can identify a potential trait or purpose for the particular type of consumable substance 104 contained within the juice pod 102 that relates to one or more nutritional and/or health benefits or effects associated with the fruit, vegetable, supplement or other product contained within the consumable juice substance 104. Table 1 below illustrates one exemplary system for the color-coded labels 118 to enable a user to select one or more juice pods 102 based on a purpose of the product contained within the consumable juice substance 104 of each juice pod 102; however, it is recognized that any other suitable type of system and conventions can be used for the color-coded labels 118 in alternative embodiments of the present invention.

TABLE 1

| Label Color | Purpose |
|---|---|
| Green | Detox |
| Red | Energy |
| Yellow | Overall |
| Brown | Fiber |
| Blue | Healing |
| Orange | Cleanse |
| White | Sweet |
| Purple | Heart |
| Pink | Antioxidants |
| Grey | Masking |

An exemplary application of the color-coded labels 118 is best illustrated in FIGS. 2B, 3B and 4A, where the particular juice pod 102 illustrated contains an apple-based consumable juice substance 104 as indicated by label 116. As illustrated, the juice pod 102 includes a first (yellow) color-coded label 118 identifying the apple-based consumable juice substance 104 contained in pod 102 as having overall nutritional benefits due to the known overall health benefits of the apple fruit. Similarly, as further illustrated, the apple-base juice pod 102 provided in FIGS. 2B, 3B and 4A includes a second (white) color-coded label 118 identifying the apple-based consumable juice substance 104 contained in the pod 102 as being sweet due to the known level of sweetness in the apple fruit. For another example, while not illustrated in the figures, a juice pod 102 containing a guava-based consumable juice substance 104 can have a first (grey) color-coded label 118 identifying the guava-based consumable juice substance 104 as a masking flavor that can mask the taste and flavor of other consumable juice products 104 added to a customizable juice beverage 106, such as bitter fruits and vegetable products, due to the guava's known strong, sweet flavor. Several other applications of color-coded labels 118 can be utilized in connection 100 and it is recognized that the specific colors and attributes/characteristics or purposes can be interchangeably used in accordance with the present invention.

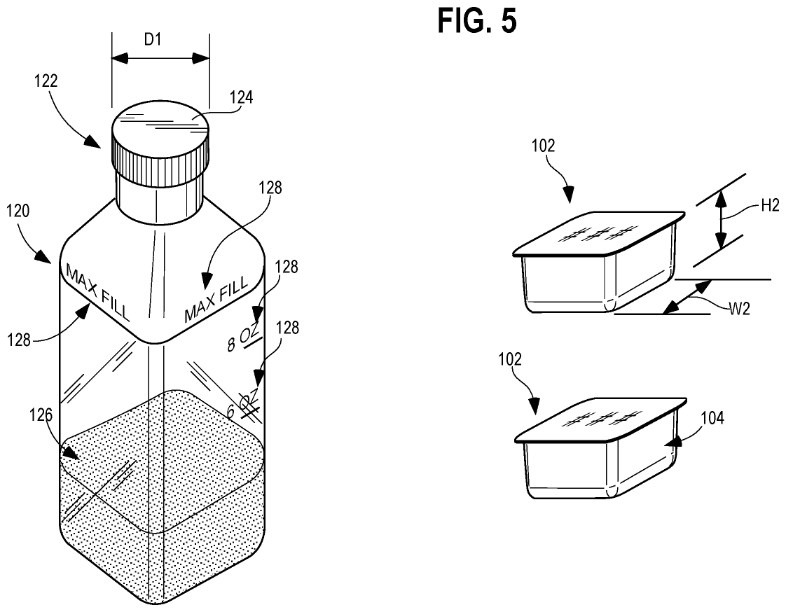

Referring now to FIG. 5, a second embodiment of system or product 100 for providing a customizable juice beverage is shown schematically. As shown, according to this embodiment, system 100 can further comprise a base juice container 120, which can be configured as any suitable type of container, bottle or vessel having an opening 122 and a removable lid or cap 124. According to one embodiment, opening 122 can be configured with a diameter greater than the height and width of the consumable juice substance 104 contained within each juice pod 102 to allow the consumable juice substances 104 to be easily inserted into base juice container 120, particularly when the consumable juice substances 104 are in a frozen state. As shown in FIG. 5, according to one embodiment, opening 122 can have a diameter D1 that is greater than both a height H2 of juice pod 102 and a width W2 of juice pod 102 to facilitate the insertion of the consumable juice substance 104 contained within juice pod 102 into container 120, particularly when consumable juice substance 104 is in a frozen state.

As further shown in FIG. 5, according to one embodiment, base juice container 120 can include have quantity of a base juice product 126 provided within container 120 to be utilized as part of a customized juice beverage 106. The base juice product 126 can comprise any suitable consumable juice-based liquid, including pre-made juices or juice substances, water or any other consumable liquid.

System 100 according to the embodiment shown in FIG. 5 can be used to create a customizable juice beverage 106 by selecting one or more juice pods 102 (based on the user's preferences), opening the juice pods 102 and inserting the consumable juice substance 104 from each selected juice pod 102 into the base juice container 120 through opening 122. The removable lid 124 can then be positioned onto the opening 122 and the base juice container 120 can be shaken to combine the base juice product 126 and consumable juice substances 104 from each selected juice pod 102 in order to create the customized juice-based beverage 106 based on the user's preferences.

As further shown in FIG. 5, base juice container 120 can include one or more pre-defined fill lines 128 provided on the outside of container 120. The fill lines 128 can indicate the amount or volume of juice product 126 and consumable juice substance(s) 104 located within container 120 to indicate to the user the total amount of juicing substance and/or number of juice pods 102 used in the creation of a customized juice beverage 106. According to one embodiment, as illustrated in FIG. 5, container 120 can include a fill line 128 identifying a maximum amount of juicing substance recommended to be placed into container 120 when creating customizable juice beverage 106 in order to facilitate the mixing and combining of different consumable juice substances 104 and/or base juice product 126. FIG. 5 further illustrates one embodiment of system 100 wherein container 120 is sized and configured to include approximately four ounces (4 oz.) of a base juice product 126 and provide space for adding the consumable juice substances 104 from two juice pods 102, each containing approximately two ounces (2 oz.) of consumable juice substance 10 as indicated by fill lines 128 indicating six ounces (6 oz.) and eight ounces (8 oz.). In addition, container 120 according to this embodiment is sized and configured to allow an additional two ounces (2 oz.) as indicated by the maximum fill line 128 for a user to allow additional ingredients, such as, but not limited to, another juice pod 102, ice, water, medicine or other consumable substance. Finally, the container 120 according to this embodiment includes additional empty volume above the maximum fill line 128 to facilitate proper mixing and combination of the added consumable juice substances 104 by shaking of container 120. It is also recognized that the embodiment illustrated in FIG. 5 and described herein represents only one potential size, shape and configuration of container 120, and that container 120 can have any suitable size, shape and configuration and can allow for the insertion of different amounts and volumes of consumable juice substances 104 depending on the particular embodiment of the present invention. It is also recognized that the fill lines 128 can be configured to indicate any desired amount of volume different from those indicated in FIG. 5 in alternative embodiments of the present invention.

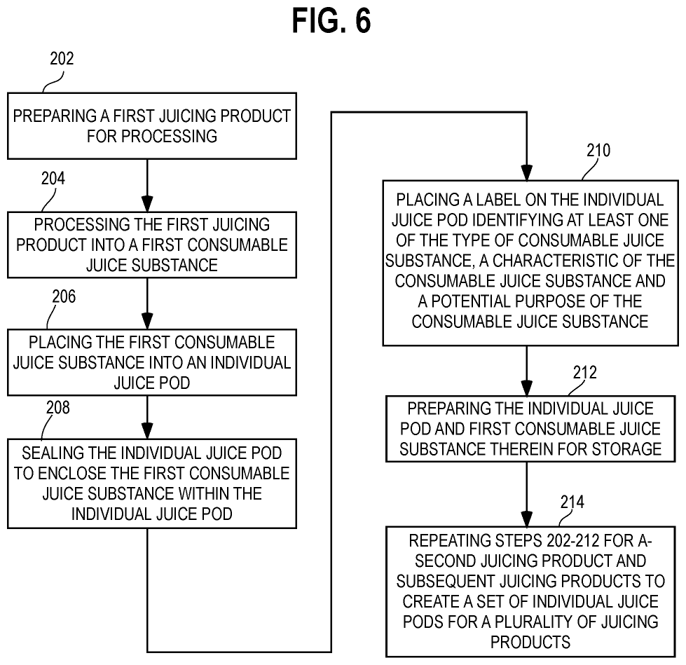

Referring now to FIG. 6, a method 200 for creating individual juice pods 102 (as best illustrated in FIGS. 1-3) is shown schematically and described in greater detail. As described above, each juice pod 102 can contain a quantity of a specific type of consumable juice substance 104 processed from one or more fruits, vegetables, nutritional supplements, flavor supplements or other consumable products. In addition, consumable juice substance 104 can be created from any suitable type of concentrate, extract or other ingredient.

As shown in FIG. 6, method 200 for creating one or more individual juice pods 102 for use in a customizable juice beverage can begin at a step 202, where a first juicing product is prepared for processing in to a consumable juice substance 104. The first juicing product can comprise any type of fruit, vegetable, supplement or other consumable product or ingredient as described in detail above. At step 202, the first juicing product can be washed and cleaned (such as for raw fruits, vegetables, grains, roots, leaves and other vegetation or other products), have a liquid added to the product (such for extracts, vitamin and mineral supplements, etc.), and be weighed and measured into a predefined serving amount or size. Next at step 204, the first juicing product can be processed into a first consumable juice substance. The first consumable juice substance can comprise a liquid, solid, jelly, powder, or frozen substance depending on the type of juicing product used as the first juicing product and the desired storage application utilized. During step 204, any suitable types of methods, techniques and processes can be utilized to transform the first juicing product into the first consumable juice substance. For example, the first juicing product can be cold pressed, blended, mixed, chopped, grinded, cooked, heated, blanched, steamed, boiled, juiced, mixed with other components, have preservatives and/or supplements added thereto, freeze dried, pasteurized, and/or any other suitable technique for deriving a juice substance from the first juicing product.

In addition, during the processing step 204, the first juicing product and/or the first consumable juice substance created therefrom can have one or more additives or supplements added in order to preserve the freshness, color, and/or taste of the first consumable juice substance and/or incorporate or enhance the nutrients or flavor of the first consumable juice substance. For example, one or more preservative additives added during step 204 can include ascorbic acid (vitamin C), lemon juice, sugars and vinegars, in order to prevent or limit enzyme deterioration of the first liquid juice substance. Other known preservatives that can also be used at step 206 to preserve the freshness and life of the first liquid juice substance, including but not limited to lactic acid, nitrates and nitrides, benzoic acid, sodium benzoate, hydroxybenzoate, propionic acid, sodium propionate, sulfur dioxide and sulfites, sorbic acid and sodium sorbate, citric acid (and citrates), and tartaric acid. Further, during step 204, the first juicing product and/or first consumable juice substance created therefrom can be pasteurized using any suitable technique; however, it is also recognized that pasteurization can be performed at a later step in method 200 in certain embodiments of the invention.

Next, at a step 206, the first consumable juice substance can be placed into a first juice pod or container (such as a juice pod 102 as described herein and illustrated in FIGS. 2-4). The first juice pod can have cavity defined therein suitable for holding a desired shape (including width and thickness) and volume of the first consumable juice substance. Next, at step 208, the first juice pod can be sealed to enclose the first consumable juice substance in the cavity within the first juice pod. During the sealing step 208, the first juice pod can be vacuum sealed using any known or suitable technique in order to remove all excess air from the cavity within the first juice pod. In addition, at step 208 (or prior to step 208), a high pressure processing or other pasteurization technique can optionally be incorporated in order to remove bacteria and microorganisms from the first consumable juice substance in certain embodiments of the present invention.

Next, at a step 210, one or more labels can be placed on the first juice pod in order to identify the type of consumable juice substance contained therein and/or a trait, characteristic or purpose of the consumable juice substance. For example, during step 210, one or more color-coded labels 118 (as illustrated in FIGS. 2-4 and described in detail above) identifying a potential purpose associated with the fruit, vegetable or other product contained within the consumable juice substance can be placed on the first juice pod to allow users of the pods to select one or more pods for a customized juice beverage based on the potential health benefits and effects of the fruits, vegetables, and other products contained within the consumable juice substances from the selected juice pods.

As further shown in FIG. 6, method 200 can include a preparation step for preparing the individual juice pod and the first consumable juice substance contained therein for storage. The storage preparation at step 212 can include one or more of high pressure processing, other type of pasteurization, freezing, or other technique for making the juice pod and consumable juice substance more shelf-stable and prolong the life, taste, flavor and nutrients of the consumable juice substance contained within the juice pod and/or remove bacteria and other microorganisms within the consumable juice substance. The storage preparation step of 212 can also be incorporated into the sealing step 208 or prior to the sealing step 208 depending on the particular technique utilized to remove bacteria and microorganisms as described above in certain embodiments of the present invention.

As further shown in FIG. 6, method 200 can include an additional step 214, where the steps 202-212 are performed for a second juicing product and subsequent juicing products in order to create a plurality of individual juice pods, each containing a different type of consumable juice substance based on a particular fruit, vegetable or other consumable product. The result is to enable a user to select on or more juice pods to create a customized juice beverage as described herein.

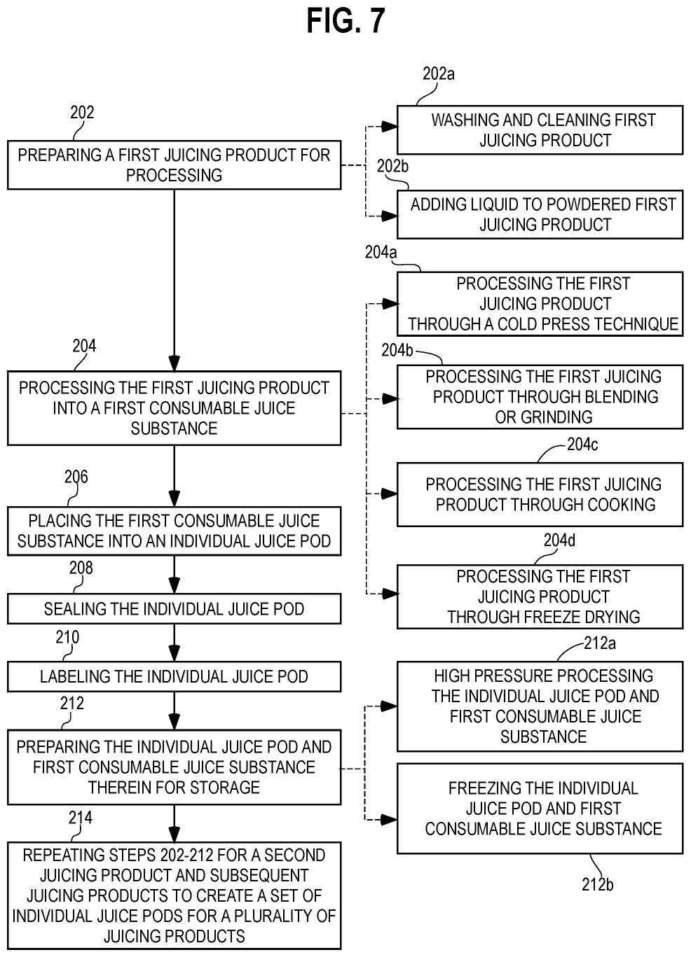

FIG. 7 illustrates an alternative embodiment of method 200 for creating one or more individual juice pods 102 for use in a customizable juice beverage showing the steps 202, 204 and 212 in greater detail. As shown in FIG. 7, step 202 can include one or more sub-steps for preparing a first juicing product for processing into a consumable juice substance. As shown, step 202 can include a step 202a, where the juicing product is washed and cleaned, and a step 202b, where the juicing product is hydrated by adding liquid. At step 204, the processing of the first juicing product into a consumable juice substance can include one or more processing sub-steps 204a-204d, for cold pressing (204a), blending or grinding (204b), cooking (204c) and freeze drying (204d). At step 212, the storage preparation of the first consumable juice substance within the individual juice pod can include one or more sub-steps for stabilizing and prolonging the shelf-life of the juice pod, including a step 212a, where the individual juice pod is high pressure processed to remove bacteria, etc., and/or a step 212b, where the individual juice pod is frozen (by and suitable means, including nitro freezing and flash freezing).

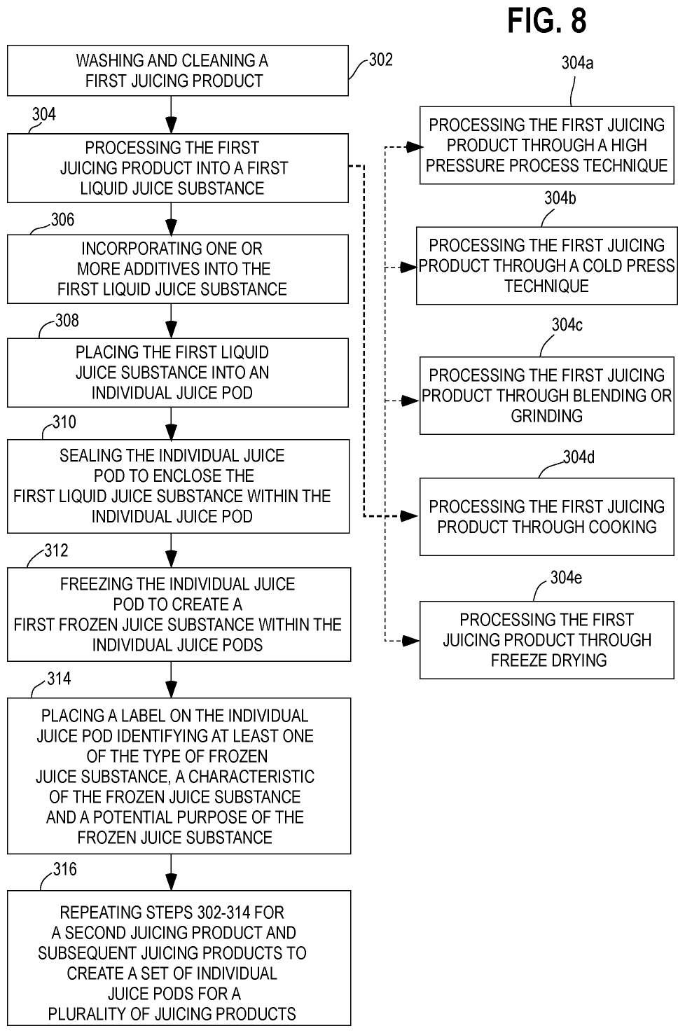

FIG. 8 illustrates an alternative method 300 for creating one or more individual juice pods 102 for use in a customizable beverage wherein the consumable juice substance is prepared as a frozen juice substance. As shown in FIG. 8, method 300 for creating one or more individual juice pods for creating a customized juice beverage can begin at a step 302, where a first juicing product is washed and cleaned (or otherwise prepared for processing). The first juicing product can comprise any type of fruit, vegetable, supplement or other consumable product or ingredient as described herein. Next, at step 304, the first juicing product can be processed into a first liquid juice substance. During step 304, any suitable types of methods, techniques and processes can be used to transform the first juicing product into the first liquid juice substance. For example, step 304 can incorporate one or more additional sub-steps including but not limited to: a step 304a where the juicing product is processed through high pressure processing techniques, a step 304b where the juicing product is processed through a cold press technique, a step 304c where the juicing product is processed through blending or grinding or mixing, a step 304d where the juicing product is processed through cooking, such as heating, blanching steaming, boiling or other method, and a step 304e where the juicing product is freeze dried. It is recognized that one or any combination of sub-steps 304a-304e can be performed during processing step 304 along with any other suitable technique for deriving a juicing substance from the first juicing product.

After the first juicing product is processed into first liquid juice substance at step 304, an optional step 306 may be performed where one or more additives may be added to the first liquid juice substance in order to preserve the freshness, color, and/or taste of the first liquid juice substance and/or to incorporate or enhance the nutrients or flavor of the first liquid juice substance. For example, one or more preservative additives can be added at step 306, such as ascorbic acid (vitamin C), lemon juice, sugars and vinegars, in order to prevent or limit enzyme deterioration of the first liquid juice substance. Other known preservatives that can also be used at step 306 to preserve the freshness and life of the first liquid juice substance, including but not limited to lactic acid, nitrates and nitrides, benzoic acid, sodium benzoate, hydroxybenzoate, propionic acid, sodium propionate, sulfur dioxide and sulfites, sorbic acid and sodium sorbate, citric acid (and citrates), and tartaric acid.

Next, at step 308, the first liquid juice substance can be placed into a first juice pod or container (such as a juice pod 102 as described herein and illustrated in FIGS. 2-4). The first juice pod can have cavity defined therein suitable for holding a desired shape (including width and thickness) and volume of the first liquid juice substance. Next, at step 310, the first juice pod can be sealed to enclose the first liquid juice substance in the cavity within the first juice pod. During the sealing step 310, the first juice pod can be vacuum sealed using any known or suitable technique in order to remove all excess air from the cavity within the first juice pod. This step 310 can also incorporate high pressure processing of the first juice pod after sealing in order to remove bacteria/germs in the first liquid juice substance. Next, at step 312, the first juice pod with the first liquid juice substance can be frozen (such as by flash freezing) in order to form a first frozen juice substance within the first juice pod.

As also illustrated in FIG. 8, method 300 can include a step 314, where one or more labels can be placed on the first juice pod in order to identify the type of frozen juice substance contained therein and/or a trait, characteristic or purpose of the frozen juice substance. For example, during step 314, one or more color-coded labels 118 identifying a potential purpose associated with the fruit, vegetable or other product contained within the frozen juice substance can be placed on the first juice pod to allow users of the pods to select one or more pods for a customized juice beverage based on the potential health benefits and effects of the fruits, vegetables, and other products contained within the frozen juice substances from the selected juice pods. In addition, while not illustrated in FIG. 8, method 300 can include a step for preparing the individual juice pod for storage by high pressure processing, pasteurization or other suitable method for prolonging the stability and shelf-life of the frozen juice substance.

As further illustrated in FIG. 8, method 300 can include an additional step 316, where the steps 302-314 are performed for a second juicing product and subsequent juicing products in order to create a plurality of individual juice pods, each containing a different type of frozen juice substance based on a particular fruit, vegetable or other consumable product. The result is to enable a user to select on or more juice pods to create a customized juice beverage as described herein.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for creating a customizable juice-based beverage, said system comprising:
a plurality of individual juice pods, wherein each individual juice pod in said plurality of individual juice pods includes an enclosed cavity and a consumable juice substance provided within said cavity;
wherein said consumable juice substance for each said individual juice pod is derived from a juicing product, and wherein said juicing product for said consumable juice substance of a first individual juice pod is different than said juicing product for said consumable juice substance of a second individual juice pod; and
wherein said consumable juice substances from one or more of said plurality of individual juice pods are configured to be combined to create said customizable juice-based beverage.

2. The system of claim 1, wherein said juicing product for said consumable juice substance of said first individual juice pod comprises a vegetable.

3. The system of claim 1, wherein said juicing product for said consumable juice substance of said first individual juice pod comprises a fruit.

4. The system of claim 1, wherein said juicing product for said consumable juice substance of said first individual juice pod comprises a nutritional supplement.

5. The system of claim 1, wherein said juicing product for said consumable juice substance of said first individual juice pod comprises a flavor supplement.

6. The system of claim 1, wherein each individual juice pod includes approximately two ounces of said consumable juice substance.

7. The system of claim 1, wherein said consumable juice substance for at least one of said individual juice pods comprises a frozen juice substance that is shaped into a thin sheet to facilitate melting of said frozen juice substance.

8. The system of claim 1, further comprising a color-coded label provided on an exterior of each said individual juice pod, wherein each color-coded label comprises a color corresponding to at least one characteristic of said consumable juice substance stored in said individual juice pod.

9. The system of claim 1, further comprising a container having a first liquid juice product located within said container and an opening, wherein a diameter of said opening is greater than a height and a width and of said individual juice pod to enable said consumable juice substance located in said individual juice pod to be inserted into said container.

10. A customizable juice product for creating a customized juice beverage, said customizable juice product comprising:
a plurality of individual juice pods, wherein each individual juice pod of said plurality of individual juice pods comprises:
a container having a cavity defined therein;
a consumable juice substance provided in said cavity, said consumable juice substance being prepared from a juicing product having one or more nutritional or flavor characteristics; and
a top covering said container and enclosing said consumable juice substance within said cavity;
wherein said plurality of individual juice pods comprises a first individual juice pod having a first consumable juice substance prepared from a first juicing product and a second individual juice substance prepared from a second juicing product;
wherein said first juicing product is different from said second juicing product.

11. The customizable juice product of claim 10, further comprising a container comprising an opening and a removable top, said container having a base liquid juice substance located within said container, wherein said consumable juice substances from one or more of said plurality of individual juice pods are configured for being deposited into said container through said opening to create said customized juice beverage.

12. The customizable juice product of claim 10, further comprising a color-coded label provided on an exterior of each said individual juice pod, wherein each said color-coded label comprises a color corresponding to at least one characteristic of said consumable juice substance stored in said individual juice pod.

13. The customizable juice product of claim 10, wherein said first juicing product comprises at least one of a fruit, vegetable, or nutritional supplement.

14. A method for creating a customizable juice product having a plurality of individual juice pods, each having a consumable juice substance provided therein, said method comprising the steps of:
providing a first juicing product;
processing said first juicing product into a first consumable juice substance;
providing a first individual juice pod having a cavity;
placing said first consumable juice substance in said cavity of said first individual juice pod;
sealing said first individual juice pod to enclose said first consumable juice substance in said cavity;
placing a label on said first individual juice pod, wherein said label identifies at least one characteristic of said first consumable juice substance;
providing a second juicing product, said second juicing product being different from said first juicing product;
processing said second juicing product into a second consumable juice substance;
providing a second individual juice pod having a cavity;
placing said second consumable juice substance in said cavity of said second individual juice pod;
sealing said second individual juice pod to enclose said second consumable juice substance in said cavity; and
placing a label on said second individual juice pod, wherein said label identifies at least one characteristic of said second consumable juice substance.

15. The method of claim 14, further comprising the step of freezing said first consumable juice substance.

16. The method of claim 15, wherein the step of freezing said first consumable juice substance includes freezing said first consumable juice substance in a sheet-like shape having a reduced thickness that facilitates melting of said first consumable juice substance.

17. The method of claim 14, wherein said label on said first individual juice pod comprises a color-coded label.

18. The method of claim 14, further comprising the step of adding one more additives to said first consumable juice substance to assist in preserving at least one of the flavor, color and freshness of said first consumable juice substance.

19. The method of claim 14, wherein the step of processing said first juicing produce includes at least one of cooking said first juicing product, cold pressing the first juicing product, freeze drying said first juicing product, blending said first juicing product, and adding a liquid to said first juicing product.

20. The method of claim 14, further comprising the step of high pressure processing said first consumable juice substance after said first consumable juice substance has been sealed within said first individual juice pod.
